(19) United States
(12) Patent Application Publication
(10) Pub. No.: US 2023/0387949 A1
(43) Pub. Date: Nov. 30, 2023

(54) COMMUNICATION SYSTEM AND COMMUNICATION METHOD

(71) Applicant: NEC Corporation, Tokyo (JP)

(72) Inventor: Osamu Hasegawa, Tokyo (JP)

(73) Assignee: NEC Corporation, Tokyo (JP)

(21) Appl. No.: 18/198,494

(22) Filed: May 17, 2023

(30) Foreign Application Priority Data
May 24, 2022 (JP) 2022-084210

(51) Int. Cl. H04B 1/04

(52) U.S. Cl. CPC H04B 1/0475

(57) ABSTRACT

A communication system in which a hub station and multiple terminal stations communicate at the same time using the same channel, wherein: the hub station has a modulator that generates a transmission signal including a prescribed known signal, a filter that generates a cancellation signal for cancelling interference, a combiner that combines the transmission signal and the cancellation signal, a transmitter that transmits the combined signal, and an updater that calculates an adaptive filter minimizing a power of an error signal relating to the known signal; each of the terminal stations has a calculator that calculates the error signal, and a transmitter that transmits the error signal; and the filter generates a cancellation signal generates the cancellation signal by performing a filtering process by the adaptive filter on the signal to be transmitted to another of the terminal stations.

This application is based upon and claims the benefit of priority from Japanese patent application No. 2022-084210, filed May 24, 2022, the disclose of which is incorporated herein in its entirety by reference.

### TECHNICAL FIELD

The present disclosure relates to a communication system and a communication method.

### BACKGROUND ART

In point-to-point wireless communication systems using the microwave/millimeter-wave band, when communicating between one hub station and multiple terminal stations, multiple frequency channels must be provided or the angles between the terminal stations must be made large in order to avoid interference on the same frequency channel, and the frequency utilization efficiency becomes poor.

The interference includes two types, i.e., from the terminal stations to the hub station and from the hub station to the terminal stations. Since the interference at the hub station is separated (interference cancellation) into multiple signals by multiple receiving antennas in the hub station, it can be handled by existing interference cancellation technology such as XPIC (cross-polarization interference canceller).

The methods for cancelling interference at the terminal stations include two possibilities, i.e., receiving compensation at the terminal stations and transmission compensation at the hub station. The former possibility, receiving compensation, requires multiple signals to be separated (by interference cancelling) at a single receiving antenna, and thus involves a complicated algorithm and requires a large circuit. The latter possibility, transmission compensation, is a method in which a transmitter in the hub station transmits a combined signal obtained by combining a transmission signal with a compensation value that cancels an interference signal at the time of reception at the terminal stations.

As related technology, Patent Document 1 (Japanese Unexamined Patent Application Publication No. H10-173579) discloses an interference cancellation method in a spatial diversity communication system in which the same signal is transmitted from multiple antennas, wherein the method involves receiving, on the receiving side, signals that have been split in two on the transmission side and that have been transmitted with a complex coefficient C multiplied with one of the split signals; performing diversity combination of the two received signals that have been received; demodulating the combined output; determining the demodulated signal; and implementing control so that, when an interference signal is included in the demodulated signal, the complex coefficient C is multiplied on the transmission side so as to minimize the mean square of the error signal E, the error signal ε being defined as the error occurring before and after the determination.

### SUMMARY

Therefore, the present disclosure has, as an example of an objective thereof, to provide a communication system and a communication method.

According to an example of an aspect disclosed herein, the communication system is a communication system having a hub station and multiple terminal stations, the hub station and the multiple terminal stations communicating at the same time using the same channel, wherein: the hub station has a modulator that generates a transmission signal including a prescribed known signal when transmitting a signal to one of the terminal stations among the multiple terminal stations, a filter that generates a cancellation signal for cancelling, regarding the transmission signal, interference due to a signal to be transmitted to another of the terminal stations, a combiner that generates a combined signal by combining the transmission signal and the cancellation signal, a transmitter that transmits the combined signal, and an updater that calculates an adaptive filter minimizing a power of an error signal between a known signal included in the combined signal received by the one of the terminal stations and the prescribed known signal, based on the error signal and the signal to be transmitted to the other of the terminal stations; the each of terminal stations has a calculator that calculates the error signal, and a transmitter that transmits the error signal; and the filter generates the cancellation signal by performing a filtering process by the adaptive filter on the signal to be transmitted to the other of the terminal stations.

According to an example of an aspect disclosed herein, the communication method is a communication method for a hub station and multiple terminal stations to communicate at the same time using the same channel, wherein the communication method includes: each of the terminal stations receiving a signal from the hub station, calculating an error signal between a known signal included in the received signal and a prescribed known signal, and transmitting the error signal to the hub station; and the hub station, when transmitting a signal to one of the terminal stations among the multiple terminal stations, calculating an adaptive filter minimizing a power of the error signal based on the error signal and a signal to be transmitted to another of the terminal stations, generating a transmission signal including the prescribed known signal, performing a filtering process by the adaptive filter on the signal to be transmitted to the other of the terminal stations to generate a cancellation signal for cancelling, regarding the transmission signal, interference due to the signal to be transmitted to the other of the terminal stations, generating a combined signal by combining the transmission signal and the cancellation signal, and transmitting the combined signal to the one of the terminal stations.

### BRIEF DESCRIPTION OF THE DRAWINGS

FIG. 1 is a diagram depicting an example of a communication system provided with an interference cancellation function according to an embodiment.

FIG. 2 is a first diagram depicting an example of a transmitter/receiver in a communication system according to an embodiment.

FIG. 3A is a diagram depicting an example of a frame format for transmission from a hub station to a terminal station according to an embodiment.

FIG. 3B is a diagram depicting an example of a frame format for transmission from a terminal station to a hub station according to an embodiment.

FIG. 4A is a first diagram depicting an example of a frame format for transmission from a hub station to a terminal station, associated with a block LMS input signal in an embodiment.

FIG. 4B is a second diagram depicting an example of a frame format for transmission from a hub station to a terminal station, associated with a block LMS input signal in an embodiment.

FIG. 4C is a first diagram depicting an example of a configuration associated with updating a transmission compensation coefficient according to an embodiment.

FIG. 4D is a second diagram depicting an example of a configuration associated with updating a transmission compensation coefficient according to an embodiment.

FIG. 4E is a third diagram depicting an example of a configuration associated with updating a transmission compensation coefficient according to an embodiment.

FIG. 5 is a diagram indicating examples of frame formats before and after initial acquisition according to an embodiment.

FIG. 6 is a second diagram depicting an example of a transmitter/receiver in a communication system according to an embodiment.

FIG. 7 is a third diagram depicting an example of a transmitter/receiver in a communication system according to an embodiment.

FIG. 8 is a flow chart depicting an example of the operations in a communication system according to an embodiment.

FIG. 9 is a schematic diagram depicting an example of a communication system not provided with an interference cancellation function.

FIG. 10 is a diagram depicting an example of a communication system having the minimum configuration.

FIG. 11 is a diagram depicting an example of the operations in a communication system having the minimum configuration.

### EXAMPLE EMBODIMENT

### Embodiments

Hereinafter, a communication system according to an embodiment disclosed herein will be explained with reference to the drawings. Regarding the configurations of portions unrelated to the present disclosure in the drawings used in the explanation below, the descriptions may be omitted or not illustrated.

### SUMMARY

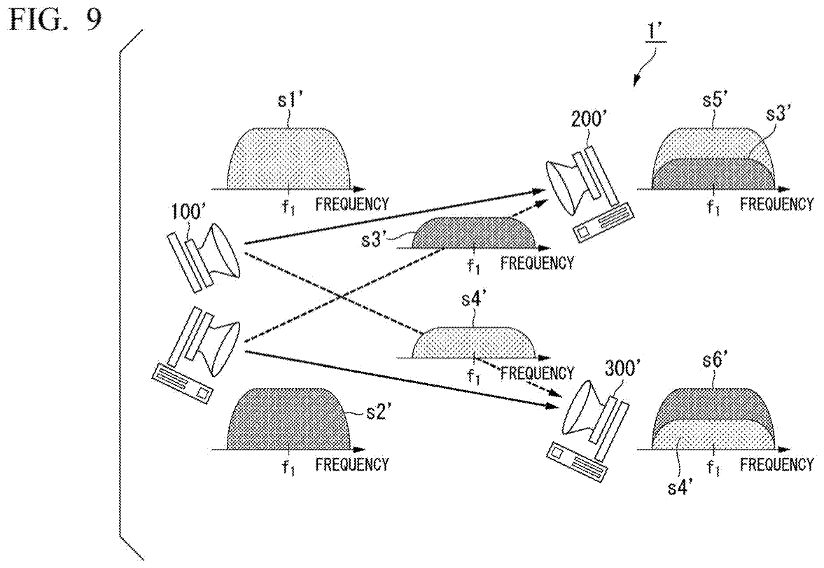

First, narrow-angle communication of a hub station 100′ not having an interference cancellation function with a terminal station 200′ and a terminal station 300′ will be explained with reference to FIG. 9. The hub station 100′ transmits the transmission signal s1′ to the terminal station 200′ and the transmission signal s2′ to the terminal station 300′ using the same frequency channel. The terminal station 200′ receives a received signal s5′ that is a combination of the transmission signal s1′ and an interference signal s3′ due to the signal transmitted to the terminal station 300′. The terminal station 300′ receives a received signal s6′ that is a combination of the transmission signal s2′ and an interference signal s4′ due to the signal transmitted to the terminal station 200′.

Thus, when narrow-angle communication is performed on the same frequency channel in this way, receiving quality at the terminal stations 200′, 300′ is degraded. When the receiving quality is poor, the number of modulation levels in the modulation scheme, i.e., the transmission capacity, cannot be increased.

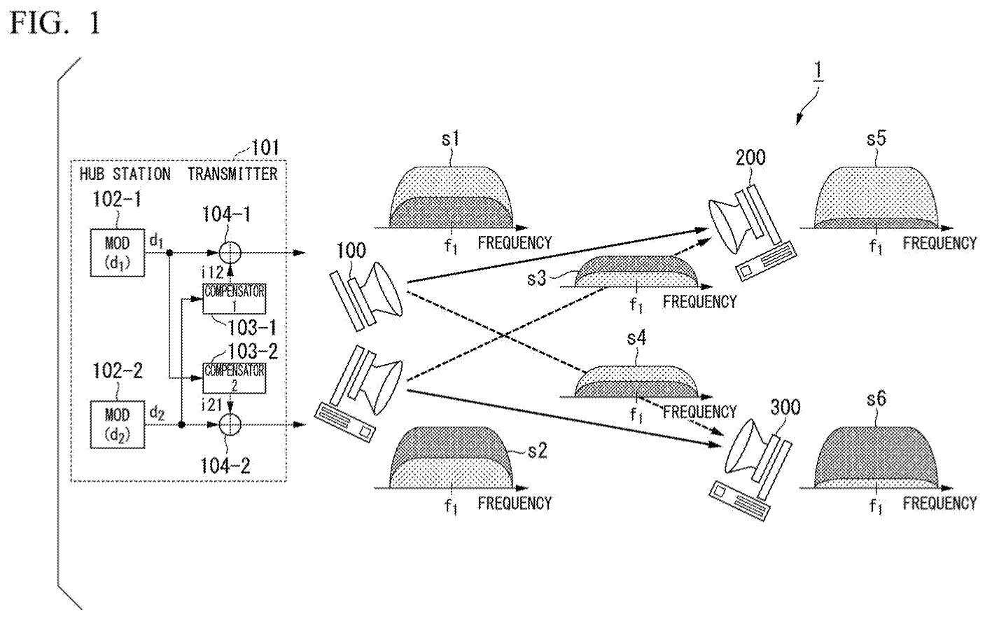

In contrast therewith, an example of a communication system 1 in which a transmitter 101 in a hub station 100 is provided with an interference cancellation function is depicted in FIG. 1. In the communication system 1, transmission compensators 103-1, 103-2 are provided in the transmitter 101 in the hub station 100. Transmission compensation in the transmitter 101 is performed by pre-combining, with the transmission signals, compensation values that cancel out at the time of reception at the terminal stations 200, 300. The transmitter 101 has modulators 102-1, 102-2, transmission compensators 103-1, 103-2, and combiners 104-1, 104-2.

The modulator 102-1 generates a modulated signal d1 by modulating a signal d1 to be transmitted to the terminal station 200, and the modulator 102-2 generates a modulated signal d2 by modulating a signal d2 to be transmitted to the terminal station 300. The transmission compensator 103-1 generates a cancellation signal i12 for cancelling interference that will be caused by the signal transmitted to the terminal station 300. The transmission compensator 103-2 generates a cancellation signal i21 for cancelling interference that will be caused by the signal transmitted to the terminal station 200. The combiner 104-1 generates a transmission signal s1 by combining the cancellation signal i12 with the modulated signal d1, and the combiner 104-2 generates a transmission signal s2 by combining the cancellation signal i21 with the modulated signal d2.

The transmitter 101 transmits the transmission signal s1 to the terminal station 200 and transmits the transmission signal s2 to the terminal station 300 using the same frequency channel. The received signal s5 of the terminal station 200 is combined with an interference signal s3 due to the transmission signal s2 to the terminal station 300, but it is cancelled by the cancellation signal i21 included in the transmission signal s1, so that a signal close to the modulated signal d1 is received at the terminal station 200. The received signal s6 of the terminal station 300 is combined with an interference signal s4 due to the transmission signal s1 to the terminal station 200, but it is cancelled by the cancellation signal i12 included in the transmission signal s2, so that a signal close to the modulated signal d2 is received at the terminal station 300. In this way, interference at the time of reception at the terminal stations 200, 300 is cancelled by transmission compensation at the hub station 100. Since the amount of interference in the received signals is reduced, the number of modulation levels in the modulation scheme, i.e., the transmission capacity, can be increased. Hereinafter, the transmission compensation method will be explained in more detail.

### (System Configuration)

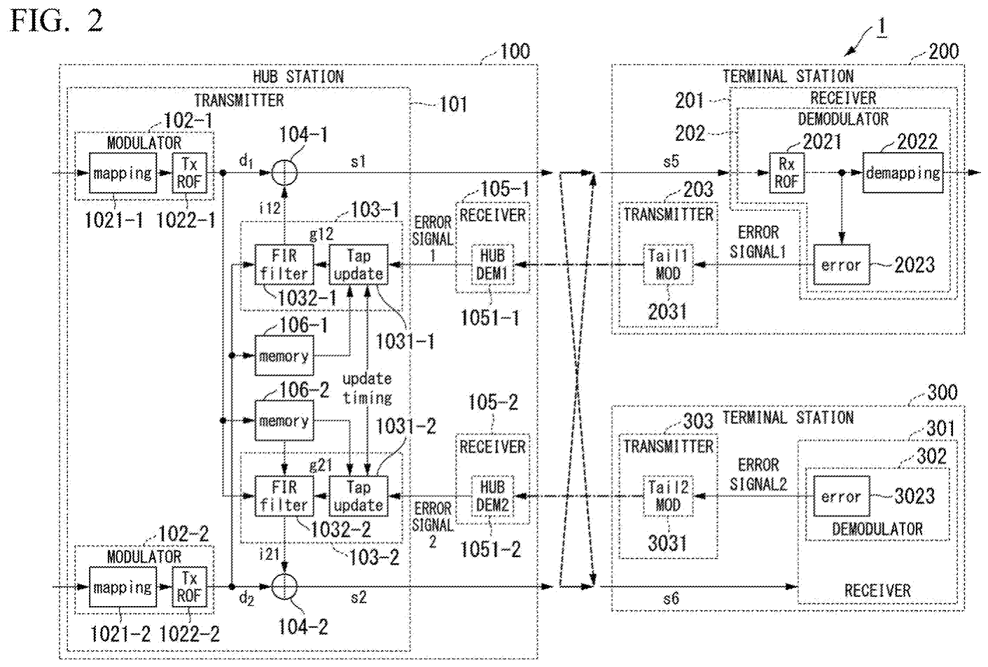

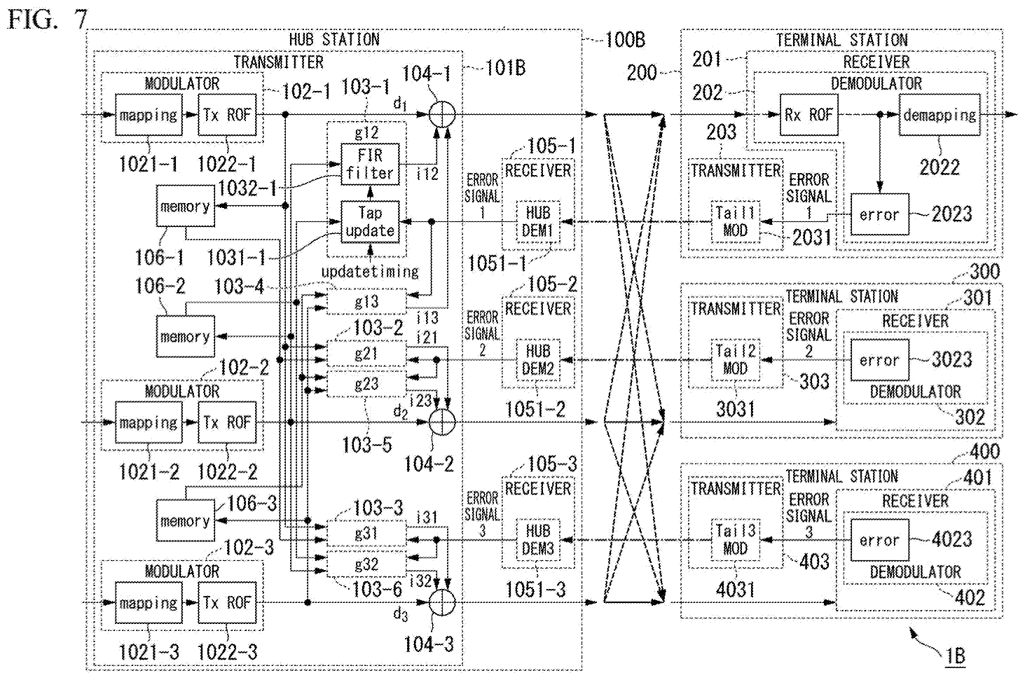

FIG. 2 is a block diagram depicting an example of a transmitter/receiver in the communication system according to an embodiment. As depicted in FIG. 2, the communication system 1 has a hub station 100 and terminal stations 200, 300. These apparatuses are, for example, bi-directional communication apparatuses using FDD (Frequency-Division Duplex) or TDD (Time-Division Duplex). Additionally, while FIG. 2 depicts a configuration for the case in which there are two terminal stations, the configuration may have three or more terminal stations (FIG. 7). The hub station 100 has a transmitter 101 and receivers 105-1, 105-2.

### (Transmitter in Hub Station)

The transmitter 101 has modulators 102-1, 102-2, transmission compensators 103-1, 103-2, combiners 104-1, 104-2, and memory units 106-1, 106-2.

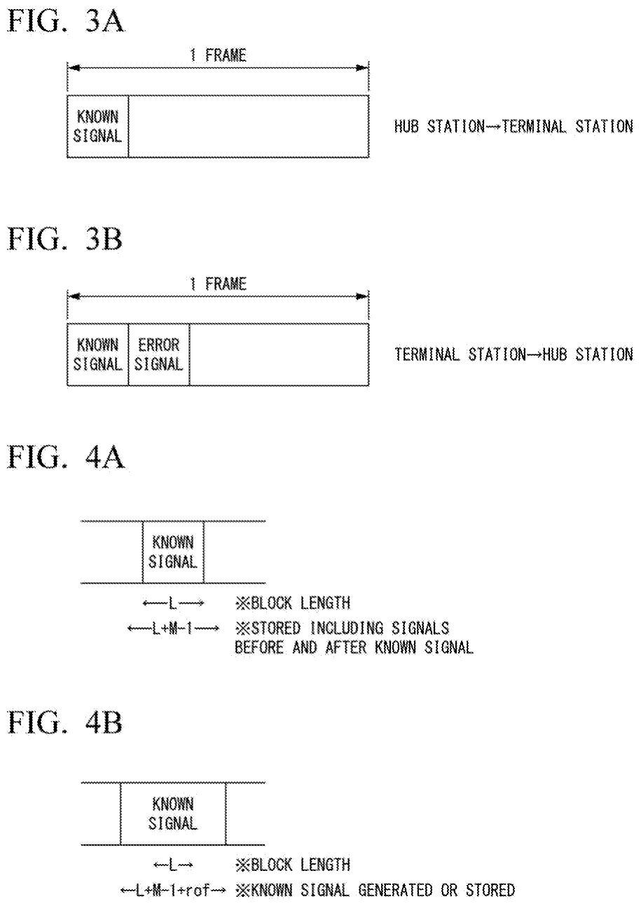

The modulator 102-1 has a mapping unit 1021-1 and a transmission ROF (Roll-Off Filter) unit 1022-1. The modulator 102-1 performs, on the signal d1 to be transmitted to the terminal station 200, a mapping process using the mapping unit 1021-1 and a modulation process, such as transmission roll-off filtering, using the transmission ROF unit 1022-1, and outputs a modulated signal d1. The modulator 102-2 has a mapping unit 1021-2 and a transmission ROF unit 1022-2. The modulator 102-2 performs, on the signal d2 to be transmitted to the terminal station 300, a mapping process using the mapping unit 1021-2 and a modulation process, such as transmission roll-off filtering, using the transmission ROF unit 1022-2, and outputs a modulated signal d2. An example of the layout of the modulated signals d1, d2 is depicted in FIG. 3A. As illustrated, a prescribed known signal is included at the head of each modulated signal d1, d2. In the present embodiment, the prescribed known signal is, for example, a preamble signal. The modulated signals d1, d2 are examples of the “transmission signal” in the claims.

The transmission compensator 103-1 has a tap updating unit 1031-1 and an FIR (Finite Impulse Response) filter unit 1032-1. The tap updating unit 1031-1 updates an FIR filter tap coefficient w in a block LMS (Least Mean Square) algorithm in an adaptive filter by means of Expression (1) below. The FIR filter tap coefficient is also referred to as a transmission compensation coefficient.

$${w}_{n} ( k + L ) = {w}_{n} ( k ) + μ {\sum }_{l = k}^{k + L - 1} {d}_{{n}^{′}} ( l ) {e}_{n}^{*} ( l ) \qquad ( 1 )$$

In the above expression, w represents the transmission compensation coefficient (FIR filter tap coefficient), M represents the tap length, L represents the block (known signal) length [symbols], μ represents the step size, d represents the input signals to the block LMS for L+M−1 terms (in the case of the transmission compensation coefficient w1, the modulated signals d2 for L+M−1 terms, and in the case of the transmission compensation coefficient w2, the modulated signals d1 for L+M−1 terms), e represents the error signals for L terms, e′ represents the complex conjugates of e, k and l represent time, n represents a terminal station number for a local terminal station (desired) signal (in the case of the transmission compensation coefficient w1, the terminal station 200), and n′ represents a terminal station number of an interference signal (in the case of the transmission compensation coefficient w1, the terminal station 300). The error signal e is information regarding the difference between a known signal included in a frame received on the terminal station side and a prescribed known signal. The tap updating unit 1031-1 calculates an FIR filter tap coefficient that minimizes the error signal e by means of a generally known block LMS algorithm.

Regarding the terms in the sigma on the right side of Expression (1), the signals for L+M−1 terms are required, as indicated in Expression (2) below.

$$[ \text{} \begin{matrix}{d}_{{n}^{′}} ( k ) & {d}_{{n}^{′}} ( k + 1 ) & {d}_{{n}^{′}} ( k + 2 ) & & {d}_{{n}^{′}} ( k + L - 2 ) & {d}_{{n}^{′}} ( k + L - 1 ) \\ {d}_{{n}^{′}} ( k - 1 ) & {d}_{{n}^{′}} ( k ) & {d}_{{n}^{′}} ( k + 1 ) & & {d}_{{n}^{′}} ( k + L - 3 ) & {d}_{{n}^{′}} ( k + L - 2 ) \\ {d}_{{n}^{′}} ( k - 2 ) & {d}_{n}^{′} ( k - 1 ) & {d}_{{n}^{′}} ( k ) & & {d}_{{n}^{′}} ( k + L - 4 ) & {d}_{{n}^{′}} ( k + L - 3 ) \\ ⋮ & ⋮ & ⋮ & ⋱ & ⋮ & ⋮ \\ {d}_{{n}^{′}} ( k - M + 1 ) & {d}_{{n}^{′}} ( k - M + 2 ) & {d}_{{n}^{′}} ( k - M + 3 ) & & {d}_{{n}^{′}} ( k + L - M - 1 ) & {d}_{{n}^{′}} ( k + L - M )\end{matrix} ] \text{} [ \begin{matrix}{e}_{n}^{*} ( k ) \\ {e}_{n}^{*} ( k + 1 ) \\ {e}_{n}^{*} ( k + 2 ) \\ ⋮ \\ {e}_{n}^{*} ( k + L - 1 )\end{matrix} ] \qquad ( 2 )$$

Additionally, as an expression obtained by simplifying the above Expression (1), the tap updating unit 1031-1 may update the transmission compensation coefficient by means of Expression (3) below.

$${w}_{n} ( k + L ) = {w}_{n} ( k ) + μ {\sum }_{l = k}^{k + L - 1} {d}_{{n}^{′}} ( l ) c sgn ( {e}_{n}^{*} ( l ) ) \qquad ( 3 )$$

As will be explained below, the above Expression (3) can be used in the case in which the terminal stations 200, 300 are configured to simplify the error signal e by feeding back only the sign thereof to the hub station 100.

In this case, the method of handling the input signal (dₙ, above) to the block LMS may be either of the two methods indicated below.

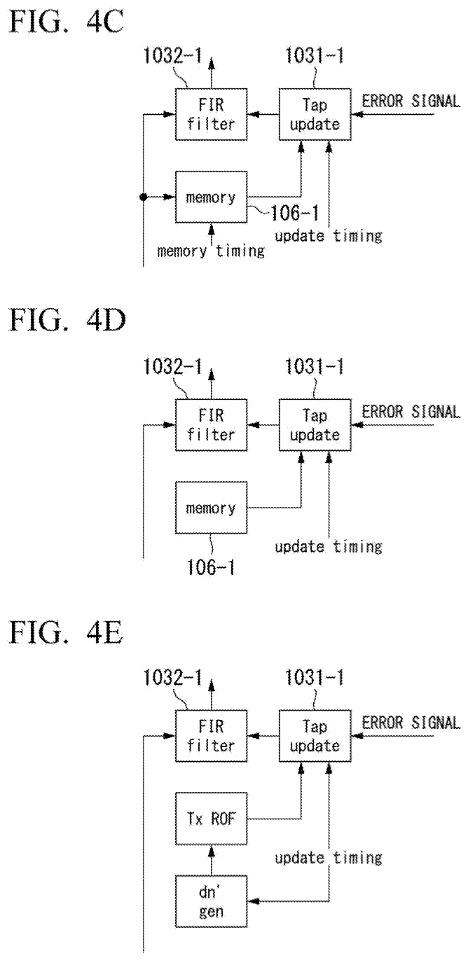

(A1) The first method is one in which the block lengths and the known signals are the same. With this method, for example, when updating the transmission compensation coefficient w₁, a known signal included in the modulated signal d2 (known signal included in a modulated signal transmitted to the terminal station that will cause interference) and random data before and after the known signal are stored in the memory 106-1 or the like, and the tap (transmission compensation coefficient w₁) is updated at the timing at which an error signal of the known signal is fed back from the terminal 200. The random data before and after the known signal are also used to update the tap of the block LMS. Thus, the known signal length is reduced and the transmission efficiency is increased. An example of the frame format for the case of a method in which the block lengths and the known signals are the same is indicated in FIG. 4A, and an example of a configuration for generating a block LMS input signal is indicated in FIG. 4C.
(A2) The second method is a method in which the known signal is extended. In this method, the known signal included in the frame formats of the modulated signals d1, d2 is composed of L (block length)+M (number of taps)−1+filter part such as ROF (Roll-Off Filter) (longer than L (block length) computed by the block LMS), so that the entire block LMS input signal is used as the known signal. To the configuration for generating the block LMS input signal, a configuration may be added for generating a known signal and performing a series of modulation processes such as transmission roll-off filtering at the timing of a tap update in which an error signal of the known signal is fed back, or by a configuration for storage in the memory 106-1 or the like. An example of the frame format for the case of a method in which the known signal is extended is indicated in FIG. 4B. An example of a configuration for the case in which the known signal is generated is indicated in FIG. 4E, and an example of a configuration for storage in the memory 106-1 or the like is indicated in FIG. 4D.

Additionally, regarding the frame format at the time of initial acquisition of the transmission compensation coefficient (when first calculating the transmission compensation coefficient), the three measures below may be taken at the time of initial acquisition in order to reduce the initial acquisition time.

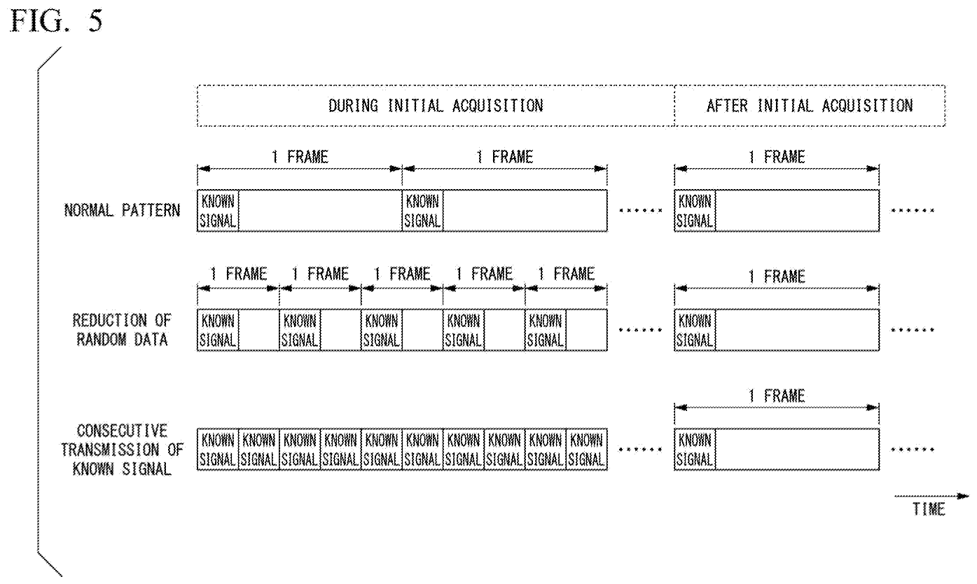

(B1) The first measure is to consecutively transmit the known signal or to reduce the random data. For example, when first calculating the transmission compensation coefficient w₁ (at the time of initial acquisition), as the frame format of the modulated signal d1, just the known signal is repeated, or the random data is reduced in comparison with a normal (after initial acquisition) frame format. In this way, the required number of data for updating the tap in the block LMS can be quickly collected and the initial acquisition time can be shortened. The frame format for the case in which just the known signal is repeated is indicated in the line “Consecutive transmission of known signal” in FIG. 5, and the frame format of the case in which the random data is reduced is indicated in the line “Reduction of random data” in FIG. 5.
(B2) The second measure is to change the block length L and/or the step size μ. By setting these values to be larger at the time of initial acquisition than the values after the initial acquisition, the initial acquisition time can be shortened.
(B3) The third measure is to perform the abovementioned (B1) and (B2) simultaneously.

Due to these measures, the transmission compensation coefficient w can be quickly set.

The FIR filter unit 1032-1 generates a cancellation signal i12 by performing, on the modulated signal d2, an FIR filter process by the transmission compensation coefficient w₁.

The transmission compensator 103-2 has the tap updating unit 1031-2 and the FIR filter unit 1032-2. The tap updating unit 1031-2 uses Expression (1) or Expression (3) above to update the transmission compensation coefficient w₂ in the block LMS algorithm. The FIR filter unit 1032-2 generates the cancellation signal i21 based on the transmission compensation coefficient w₂ and the modulated signal d1. The functions themselves of the tap updating unit 1031-2 and the FIR filter unit 1032-2 are respectively the same as those of the tap updating unit 1031-1 and the FIR filter unit 1032-1.

The combiner 104-1 generates the transmission signal s1 by combining the modulated signal d1 and the cancellation signal i12. The combiner 104-2 generates the transmission signal s2 by combining the modulated signal d2 and the cancellation signal i21. The memory units 106-1, 106-2 store various types of information. The transmission signals s1, s2 are examples of the “combined signal” in the claims.

The transmitter 101 transmits the transmission signal s1 to the terminal station 200 and transmits the transmission signal s2 to the terminal station 300 at the same time using the same channel.

### (Receiver in Hub Station)

The receiver 105-1 has a demodulator 1051-1, and uses the demodulator 1051-1 to execute a demodulation process, such as receiving roll-off filtering, carrier recovery, clock recovery, error signal calculation, or equalization, to extract an “error signal 1” included in a signal received from the terminal station 200. The receiver 105-1 outputs the extracted “error signal 1” to the tap updating unit 1031-1. The receiver 105-2 has a demodulator 1051-2, and uses the demodulator 1051-2 to execute a demodulation process, such as receiving roll-off filtering, carrier recovery, clock recovery, error signal calculation, or equalization, to extract an “error signal 2” included in a signal received from the terminal station 300. The receiver 105-2 outputs the extracted “error signal 2” to the tap updating unit 1031-2.

### (Receivers in Terminal Stations)

The terminal station 200 has a receiver 201 and a transmitter 203. The receiver 201 receives the received signal s5 obtained by combining the interference signal s3 with the transmission signal s1 transmitted from the hub station 100. The receiver 201 has a demodulator 202. The demodulator 202 has an ROF unit 2021 that performs receiving roll-off filtering, a demapping unit 2022, and an error signal calculation unit 2023. The demodulator 202 performs demodulation such as receiving roll-off filtering, carrier recovery, clock recovery, or equalization. During the demodulation processing step, the error signal calculation unit 2023 calculates an error signal (“error signal 1”). In this case, if the “error signal 1” is defined as e1, then in the terminal station 200, the error signal e1 for the case of the known signal interval is the difference between the signal r1′ and the modulated signal d1 included in the received signal s5 (e1=d1−r1′). In this case, the signal r1′ is the signal obtained after the series of demodulation processes has ended (the demodulated demapping input signal). The error signal calculation unit 2023 outputs the “error signal 1” to the transmitter 203. Additionally, the demodulated signal is demapped by the demapping unit 2022.

The error signal calculation unit 2023 may calculate a simplified error signal by means of the following Expression (4).

c sgn(e)=sgn(Re(e))+j·sgn(Im(e)) (4)

In this case, csgn is the sgn function for complex numbers. If sgn(0)=+1, then it can be output as the MSB (most significant bit), which is a single bit. The error signal calculation unit 2023 may feed back only the sign of the error signal by means of Expression (4).

### (Transmitters in Terminal Stations)

The transmitter 203 has a modulator 2031. The modulator 2031 modulates signals (for example, error signals or data transmitted from the terminal station 200) to be transmitted to the hub station 100. The transmitter 203 transmits the modulated signals to the hub station 100. After initial acquisition in the demodulation process, the transmitter 203 transmits (feeds back), from the terminal station 200 to the hub station 100, the transmission signals in which information regarding an “error signal 1” corresponding to a known signal transmitted from the hub station 100 is included in the frame format. FIG. 3B indicates an example of the layout of a signal transmitted by the terminal station 200. As illustrated, the prescribed known signal is included at the head of the signal, and the error signal follows thereafter. The “error signal 1” is used to update the transmission compensation coefficient w₁ in the hub station 100.

The matters explained regarding the terminal station 200 similarly apply to the terminal station 300. The terminal station 300 has a receiver 301 and a transmitter 303. The receiver 301 receives a received signal s6 that is a combination of the interference signal s4 and the transmission signal s2 transmitted from the hub station 100. Although the specifics have been omitted from the illustration, the receiver 301 has a configuration similar to that of the receiver 201 in the terminal station 200, such as a demodulator 302. Although the specifics have been omitted from the illustration, the demodulator 302 has a configuration similar to that of the demodulator 202 in the terminal station 200, such as an error signal calculation unit 3023, etc. The receiver 301 has the demodulator 302. The demodulator 302 has the error signal calculation unit 3023, etc. The error signal calculation unit 3023, in the case of a known signal interval, calculates an “error signal 2” from a demapping input signal and the known signal in the modulated signal d2 included in the received signal s6. The transmitter 303 has a modulator 3031. The modulator 3031 modulates the signal including the “error signal 2”, and the transmitter 303 transmits (feeds back) the modulated signal to the hub station 100. The “error signal 2” is used to update the transmission compensation coefficient w₂ in the hub station 100.

### Example of Configuration in Case of Error Correction Coding

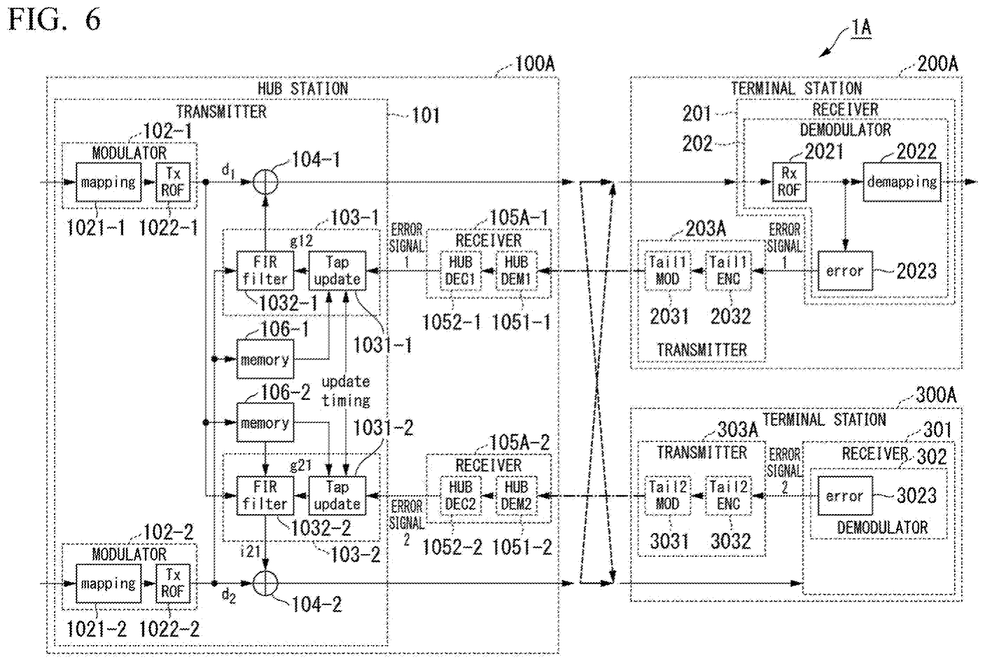

The error signals transmitted from the terminal stations 200, 300 may also be subjected to error correction coding. FIG. 6 depicts an example of the configuration of a communication system 1A in the case in which error correction coding is performed. The hub station 100A in the communication system 1A indicated in FIG. 6 has a transmitter 101 and receivers 105A-1, 105A-2. The receiver 105A-1 has a decoder 1052-1 in addition to the demodulator 1051-1, and the receiver 105A-2 has a decoder 1052-2 in addition to the demodulator 1051-2. The terminal station 200A has a receiver 201 and a transmitter 203A. The terminal station 300A has a receiver 301 and a transmitter 303A. The transmitter 203A in the terminal station 200A has an encoder 2032 in addition to the modulator 2031, and the transmitter 303A in the terminal station 300A has an encoder 3032 in addition to the modulator 3031.

The encoder 2032 encodes the “error signal 1” so as to allow error detection and correction. The modulator 2031 modulates the signal including the “error signal 1” after coding. The transmitter 203A transmits the modulated signal to the hub station 100A. In the hub station 100A, the receiver 105A-1 receives the signal, the decoder 1052-1 performs error detection and correction on the encoded “error signal 1” that has been extracted by the demodulator 1051-1, and outputs the demodulated “error signal 1” to the tap updating unit 1031-1.

The same applies to the encoder 3032 in the transmitter 303A in the terminal station 300A and to the decoder 1052-2 in the receiver 105A-2 in the hub station 100A. In FIG. 6, the specific configuration of the receiver 301 is omitted from illustration. However, the configuration and functions thereof are similar to those of the receiver 201.

### Example of Configuration in Case of Three Terminal Stations

An example of the configuration for the case in which there are three terminal stations is depicted in FIG. 7. The communication system 1B has a hub station 100B and terminal stations 200, 300, 400. The configuration of the terminal station 400 is similar to that of the terminal station 200 explained by using FIG. 2. The hub station 100B has a transmitter 101B and receivers 105-1, 105-2, 105-3. The transmitter 101B has modulators 102-1, 102-2, 102-3, transmission compensators 103-1, 103-2, 103-3, 103-4, 103-5, 103-6, and combiners 104-1, 104-2, 104-3. In FIG. 7, the specific configurations of the receivers 301, 401 are omitted from illustration. However, the configurations and functions thereof are similar to those of the receiver 201.

The generation of a transmission signal to be transmitted to the terminal station 200 will be explained. The modulator 102-1 generates the modulated signal d1. The transmission compensator 103-1 generates a cancellation signal i12 for cancelling an interference signal due to the signal transmitted from the hub station 100B to the terminal station 300. The transmission compensator 103-4 generates a cancellation signal i13 for cancelling an interference signal due to the signal transmitted from the hub station 100B to the terminal station 400 based on the “error signal 1”, the modulated signal d3 generated by the modulator 102-3, and the transmission compensation coefficient calculated by the above-mentioned Expression (1) or Expression (3). The combiner 104-1 combines the modulated signal d1, the cancellation signal i12, and the cancellation signal i13 to generate the transmission signal s1. The configuration of the transmission compensator 103-4 is similar to that of the transmission compensator 103-1. The same applies to the generation of the signals to be transmitted to the terminal stations 300, 400. Thus, in the case of a three-station configuration, the transmission compensation in the hub station 100B involves generating cancellation signals that compensate for terminal station interference from two stations, and generating a transmission signal by combining the cancellation signals for the two stations with the modulated signal to be transmitted.

Similarly, if there are four or more terminal stations, then the system is configured to generate cancellation signals that compensate for terminal station interference from three stations. The same applies to the case in which there are five or more terminal stations. In the configuration indicated in FIG. 7, for example, in the case in which there is little interference between the terminal station 200 and the terminal station 400, the operations of the transmission compensator 103-4 and the transmission compensator 103-3 may be stopped, or these circuits may be omitted.

### (Operations)

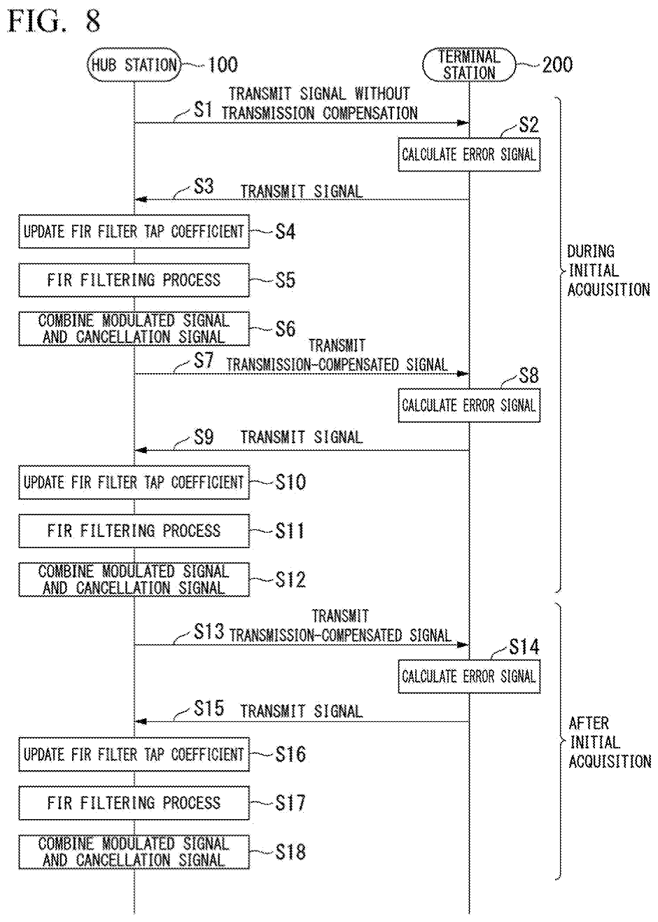

Next, using the configuration of FIG. 2 as an example, the operations of the communication system 1 will be explained with reference to FIG. 8. For convenience of explanation, the explanation will be made with communication between the hub station 100 and the terminal station 200 as an example. FIG. 8 is a flow chart indicating an example of the operations in the communication system according to an embodiment.

It will be assumed that the modulated signal d1 and the modulated signal d2 to be transmitted to the respective terminal stations 200, 300 are synchronized in terms of the timing in each symbol period and are synchronized in terms of carrier frequency. Additionally, the processes below (processes for transmission compensation for interference cancellation between terminal stations) are initiated under the assumption that the receiving quality in the hub station 100 is in a good and stable state (for example, a state in which a hub station receiving error power of −20 [dB] or lower is introduced), such as by introducing interference cancellation of the transmission signals from the terminal station 200 and the transmission signals from the terminal station 300. This is in order to keep the error signal information received at the hub station 100 free of errors.

If the modulation scheme for the known signal or the error signal is QPSK (Quadrature Phase-Shift Keying), BPSK (Binary Phase-Shift Keying), etc., in which the number of modulation levels is small, then the processes may be initiated even under conditions in which the receiving quality is relatively poor.

### (During Initial Acquisition)

During initial acquisition (before transmission compensation), only the modulated signal is transmitted from the hub station 100 to the terminal station 200 (step S1). The frame format of this transmission signal includes a known signal. Additionally, the frame format at the time of initial acquisition may be the format indicated by “Reduction of random data” or “Consecutive transmission of known signal” in FIG. 5 ((B1) above). In the terminal station 200, the error signal calculation unit 2023 calculates the “error signal 1” (step S2). The transmitter 203 transmits a signal including the “error signal 1” to the hub station 100 (step S3). For each frame, in the hub station 100, the tap updating unit 1031-1 updates the FIR filter tap coefficient (step S4). At this time, the block length L or the step size μ may be set to a value larger than those after the initial acquisition ((B2) above). Next, the FIR filtering unit 1032-1 performs the FIR filtering process on the modulated signal d2 based on the FIR filter tap coefficient (step S5). As a result thereof, the cancellation signal i12 is generated. Next, the combiner 104-1 combines the modulated signal d1 with the cancellation signal i12 (step S6). As a result thereof, the transmission signal s1 is generated. Next, the transmitter 101 transmits the transmission-compensated signal (i.e., the transmission signal s1) (step S7). The terminal station 200 calculates the “error signal 1” corresponding to the transmission signal s1 (step S8), and transmits a signal including that “error signal 1” to the hub station 100 (step S9). Then, the processes of steps S7 to S12 are repeated until the initial acquisition is completed (regarding the determination of completion of the initial acquisition, for example, the initial acquisition can be determined to have been completed when, for example, the square of the amplitude of the “error signal 1” or the average value of the power (when the error signal e1 is defined as e1=e1+j×e1_{q}, where e1 is the real part of the error signal 1, e1_{q} is the imaginary part of the error signal 1, and * is the complex conjugate, then the power of the error signal 1 is e1²=e1×e1*=e1ᵢ²+e1_{q}²=|e1|²) of the “error signal 1” becomes a prescribed threshold value or lower, or the initial acquisition can be considered to have been completed when an estimated SNR (Signal-to-Noise Ratio) becomes a prescribed set value or higher; alternatively, the initial acquisition can be determined to have been completed when a prescribed time period elapses after the initial acquisition starts or when a prescribed number of frames have been processed). Step S10 is a process for updating the FIR filter tap coefficient, similar to step S4. Step S11 is an FIR filtering process for the modulated signal d2, similar to step S5. Step S12 is a process, by the combiner 104-1, for combining the modulated signal d1 with the cancellation signal i12, similar to step S6. The tap updating unit 1031-1 updates the FIR filter tap coefficient by repeating the processes in steps S7 to S12. In an adaptive algorithm for a block LMS, the FIR filter tap coefficient is automatically updated, by an MMSE (Minimum Mean Square Error) criterion, so as to minimize the power of the error signal.

### (After Initial Acquisition)

When the initial acquisition is completed, post-initial acquisition processes are executed. Specifically, prescribed values (values smaller than those at the time of initial acquisition) are set for the block length L and the step size ii, and the transmitter 101 transmits a transmission-compensated signal (i.e., the transmission signal s1) (step S13). In the terminal station 200, the “error signal 1” corresponding to the transmission signal s1 is calculated (step S14), and a signal including the “error signal 1” is transmitted to the hub station 100 (step S15). In the hub station 100, the tap updating unit 1031-1 updates the FIR filter tap coefficient (step S16). Next, the FIR filtering unit 1032-1 performs FIR filter processing on the modulated signal d2 based on the FIR filter tap coefficient, thereby generating the cancellation signal i12 (step S17). Next, the combiner 104-1 combines the modulated signal d1 with the cancellation signal i12, thereby generating the transmission signal s1 (step S18). After the initial acquisition, the known signal included in the transmission signal s1 becomes a normal pattern as indicated in the “After initial acquisition” column in FIG. 5. Thereafter, the processes of step S13 and later are repeated.

### Effects

According to the present embodiment, when communicating from one hub station to multiple terminal stations, interference between terminal stations on the same frequency channel is cancelled by transmission compensation in a transmitter in the hub station. As a result thereof, even when performing narrow-angle communication with multiple terminal stations, a single frequency channel can be shared by multiple terminal stations, thereby increasing the frequency utilization efficiency and the transmission efficiency, and allowing operating costs to be reduced.

### (Minimum Configuration)

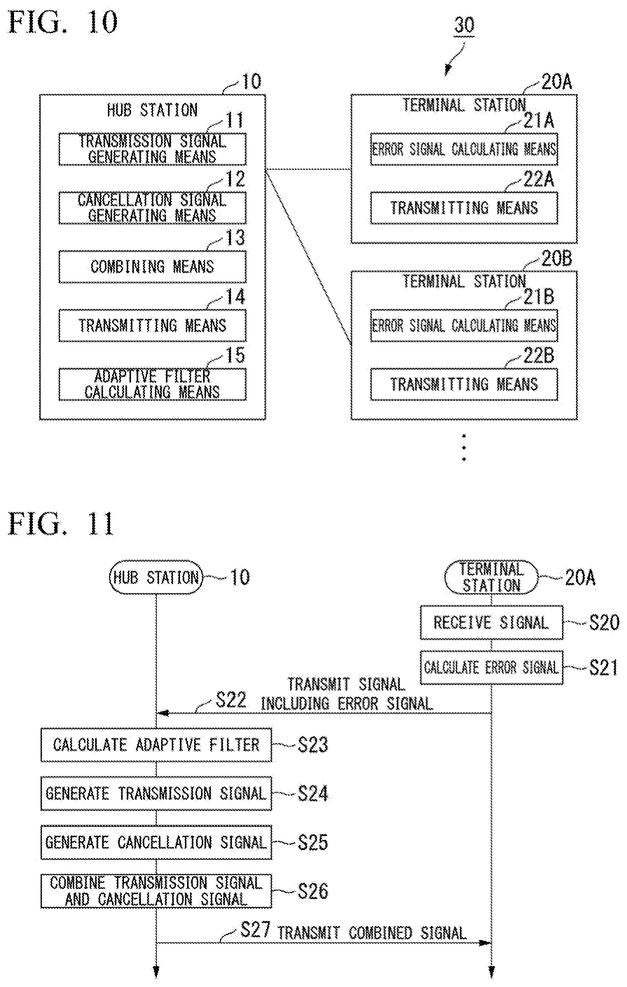

FIG. 10 is a block diagram indicating the configuration of a communication system having the minimum configuration.

The communication system 30 is provided with a hub station 10 and multiple terminal stations 20A, 20B, . . . The communication system 30 implements communication from the hub station 10 to the multiple terminal stations 20A, 20B, . . . by using the same channel. The hub station 10 has transmission signal generating means (hereinafter also referred to as “modulator”) 11, cancellation signal generating means (hereinafter also referred to as “filter”) 12, combining means (hereinafter also referred to as “combiner”) 13, transmitting means (hereinafter also referred to as “transmitter”) 14, and adaptive filter calculating means (hereinafter also referred to as “updater”) 15. The transmission signal generating means 11 generates a transmission signal including a prescribed known signal when transmitting a signal (frame) to one terminal station among the multiple terminal stations 20A, 20B, . . . , for example, to the terminal station 20A. The cancellation signal generating means 12 generates, regarding the transmission signal, a cancellation signal for cancelling interference due to a signal to be transmitted to another terminal station, for example, the terminal station 20B. The combining means 13 combines the transmission signal with the cancellation signal. The transmitting means 14 transmits the combined signal. The adaptive filter calculating means 15 calculates, using a block LMS algorithm, an adaptive filter such that the power of an error signal between the known signal included in the combined signal received by the terminal station 20A and the prescribed known signal is minimized, based on the error signal and the signal transmitted to the other terminal station 20B. The terminal station 20A has error signal calculating means (hereinafter also referred to as “calculator”) 21A for calculating the error signal and error signal transmitting means (hereinafter also referred to as “transmitter”) 22A for transmitting the error signal. The terminal station 20B has an error signal calculating means 21B for calculating the error signal and an error signal transmitting means 22B for transmitting the error signal.

FIG. 11 is a flow chart indicating processes performed by the communication system having the minimum configuration.

The terminal station 20A receives a signal from the hub station 10 (step S20). The error signal calculating means 21A in the terminal station 20A calculates an error signal between the known signal included in the signal received by the terminal station and a prescribed known signal (step S21). The error signal transmitting means 22A in the terminal station 20A transmits the error signal (step S22).

The adaptive filter calculating means 15 in the hub station 10 calculates an adaptive filter such that the power of the error signal is minimized based on the error signal and the signal transmitted to the other terminal station 20B (step S23). The transmission signal generating means 11 generates a transmission signal to the terminal station 20A including the prescribed known signal (step S24). The cancellation signal generating means 12 generates a cancellation signal by performing a filtering process by means of the adaptive filter on the signal to be transmitted to the other terminal station (step S25). The combining means 13 generates a combined signal by combining the transmission signal and the cancellation signal (step S26). The transmitting means 14 transmits the combined signal (step S27).

The whole or part of the example embodiments disclosed above can be described as, but not limited to, the following appendixes.

### (Appendix 1)

A communication system having a hub station and multiple terminal stations, the communication system implementing communication from the hub station to the multiple terminal stations using the same channel, wherein the hub station has means for generating a transmission signal (for example, a modulated signal d1) including a prescribed known signal when transmitting a signal to one of the terminal stations among the multiple terminal stations, means for generating a cancellation signal for cancelling, regarding the transmission signal, interference due to a signal to be transmitted to another of the terminal stations; means for generating a combined signal (for example, transmission signal s1) by combining the transmission signal and the cancellation signal, means for transmitting the combined signal, and means for calculating an adaptive filter minimizing a power of an error signal between a known signal included in the combined signal received by the one of the terminal stations and the prescribed known signal, based on the error signal and the signal to be transmitted to the other of the terminal stations; each of the terminal stations has means for calculating the error signal, and means for transmitting the error signal; and the means for generating a cancellation signal generates the cancellation signal by performing a filtering process by the adaptive filter on the signal to be transmitted to the other of the terminal stations.

### (Appendix 2)

The communication system according to Appendix 1, wherein, when L represents a block length, μ represents a step size, d represents an input signal to a block LMS (Least Mean Square), e represents an error signal, k and l represent time, n represents a number of the terminal station that is the transmission destination of the combined signal, and n′ represents a number of the other of the terminal stations (a terminal station that causes interference) associated with the interference, the means for calculating the adaptive filter calculates an FIR filter tap coefficient wₙ in a block LMS algorithm by using the following expression:

$${w}_{n} ( k + L ) = {w}_{n} ( k ) + μ {\sum }_{l = k}^{k + L - 1} {d}_{{n}^{′}} ( l ) {e}_{n}^{*} ( l )$$

### (Appendix 3)

The communication system according to Appendix 1, wherein, when L represents a block length, μ represents a step size, d represents an input signal to a block LMS (Least Mean Square), e represents an error signal, k and l represent time, n represents a number of the terminal station that is the transmission destination of the combined signal, n′ represents a number of the other of the terminal stations, and csgn(e)=sgn(Re(e))+j·sgn(Im(e)), the means for calculating the adaptive filter calculates an FIR filter tap coefficient wₙ in a block LMS algorithm by using the following expression:

$${w}_{n} ( k + L ) = {w}_{n} ( k ) + μ {\sum }_{l = k}^{k + L - 1} {d}_{{n}^{′}} ( l ) c sgn ( {e}_{n}^{*} ( l ) )$$

### (Appendix 4)

The communication system according to Appendix 2 or Appendix 3, wherein the input signal to the block LMS includes data and the known signal to be transmitted to the other of the terminal stations (a terminal station that causes interference) associated with the interference.

### (Appendix 5)

The communication system according to Appendix 2 or Appendix 3, wherein the input signal to the block LMS includes only the known signal.

### (Appendix 6)

The communication system according to any one of Appendix 2 to Appendix 5, wherein, when calculating the FIR filter tap coefficient wₙ during initial acquisition, the means for generating the transmission signal generates a signal repeating only the known signal, or generates a signal in which data to be transmitted to the one of the terminal stations is reduced in comparison with a signal after the initial acquisition.

### (Appendix 7)

The communication system according to any one of Appendix 2 to Appendix 6, wherein, when calculating the FIR filter tap coefficient wₙ during initial acquisition, the means for calculating the adaptive filter sets the block length L and/or the step size μ to a value larger than that after the initial acquisition.

### (Appendix 8)

A communication method for implementing communication from a hub station to multiple terminal stations using the same channel, wherein the communication method includes each of the terminal stations calculating an error signal between a known signal included in a received signal and a prescribed known signal, and transmitting the error signal to the hub station; and the hub station, when transmitting a signal to one of the terminal stations among the multiple terminal stations, calculating an adaptive filter minimizing a power of the error signal based on the error signal and a signal to be transmitted to another of the terminal stations, generating a transmission signal including the prescribed known signal, performing a filtering process by the adaptive filter on the signal to be transmitted to the other of the terminal stations to generate a cancellation signal for cancelling, regarding the transmission signal, interference due to the signal to be transmitted to the other of the terminal station, generating a combined signal by combining the transmission signal and the cancellation signal, and transmitting the combined signal to the one of the terminal stations.

As described above, interference cancellation technology is disclosed. When implementing communication from one hub station to multiple terminal stations, a method for cancelling interference between the terminal stations on the same frequency channel by transmission compensation with a transmitter of the hub station is sought.

According to the present disclosure, for example, interference between terminal stations on the same frequency channel can be cancelled.

While an embodiment disclosed herein has been explained in detail above with reference to the drawings, the specific configurations are not limited to those described above, and various design changes or the like are possible within a range not departing from the spirit of this disclosure. Additionally, an embodiment disclosed herein can be changed in various ways within the scope indicated by the claims, and embodiments obtained by appropriately combining technical means disclosed respectively in different embodiments are included within the technical scope disclosed herein. Additionally, configurations in which elements described in the above-mentioned embodiments and modified examples are replaced by elements providing similar effects are also included.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. A communication system having a hub station and multiple terminal stations, the hub station and the multiple terminal stations communicating at the same time using the same channel, wherein:
the hub station comprises
a modulator that generates a transmission signal including a prescribed known signal when transmitting a signal to one of the terminal stations among the multiple terminal stations,
a filter that generates a cancellation signal for cancelling, regarding the transmission signal, interference due to a signal to be transmitted to another of the terminal stations;
a combiner that generates a combined signal by combining the transmission signal and the cancellation signal,
a transmitter that transmits the combined signal, and
an updater that calculates an adaptive filter minimizing a power of an error signal between a known signal included in the combined signal received by the one of the terminal stations and the prescribed known signal, based on the error signal and the signal to be transmitted to the other of the terminal stations;
each of the terminal stations comprises
a calculator that calculates the error signal, and
a transmitter that transmits the error signal; and
the filter generates the cancellation signal by performing a filtering process by the adaptive filter on the signal to be transmitted to the other of the terminal stations.

2. The communication system according to claim 1, wherein
when L represents a block length, μ represents a step size, d represents an input signal to a block LMS (Least Mean Square), e represents an error signal, k and l represent time, n represents a number of the terminal station that is the transmission destination of the combined signal, and n′ represents a number of the other of the terminal stations associated with the interference, the updater calculates an FIR filter tap coefficient wₙ in a block LMS algorithm by using the following expression:
$${w}_{n} ( k + L ) = {w}_{n} ( k ) + μ {\sum }_{l = k}^{k + L - 1} {d}_{{n}^{′}} ( l ) {e}_{n}^{*} ( l )$$

3. The communication system according to claim 1, wherein
when L represents a block length, μ represents a step size, d represents an input signal to a block LMS (Least Mean Square), e represents an error signal, k and l represent time, n represents a number of the terminal station that is the transmission destination of the combined signal, n′ represents a number of the other of the terminal stations, and csgn(e)=sgn(Re(e))+j·sgn(Im(e)), the updater calculates an FIR filter tap coefficient wₙ in a block LMS algorithm by using the following expression:
$${w}_{n} ( k + L ) = {w}_{n} ( k ) + μ {\sum }_{l = k}^{k + L - 1} {d}_{{n}^{′}} ( l ) c sgn ( {e}_{n}^{*} ( l ) )$$

4. The communication system according to claim 2, wherein
the input signal to the block LMS includes data and the known signal to be transmitted to the other of the terminal stations associated with the interference.

5. The communication system according to claim 2, wherein
the input signal to the block LMS includes only the known signal.

6. The communication system according to claim 2, wherein
when calculating the FIR filter tap coefficient wₙ during initial acquisition, the updater generates a signal repeating only the known signal, or generates a signal in which data to be transmitted to the one of the terminal stations is reduced in comparison with a signal after the initial acquisition.

7. The communication system according to claim 2, wherein
when calculating the FIR filter tap coefficient wₙ during initial acquisition, the updater sets the block length L and/or the step size μ to a value larger than that after the initial acquisition.

8. The communication system according to claim 3, wherein
the input signal to the block LMS includes data and the known signal to be transmitted to the other of the terminal stations associated with the interference.

9. The communication system according to claim 3, wherein
the input signal to the block LMS includes only the known signal.

10. The communication system according to claim 3, wherein
when calculating the FIR filter tap coefficient wₙ during initial acquisition, the updater generates a signal repeating only the known signal, or generates a signal in which data to be transmitted to the one of the terminal stations is reduced in comparison with a signal after the initial acquisition.

11. The communication system according to claim 3, wherein
when calculating the FIR filter tap coefficient wₙ during initial acquisition, the updater sets the block length L and/or the step size μ to a value larger than that after the initial acquisition.

12. A communication method for a hub station and multiple terminal stations to communicate at the same time using the same channel, wherein the communication method comprises:
each of the terminal stations
receiving a signal from the hub station,
calculating an error signal between a known signal included in the received signal and a prescribed known signal, and
transmitting the error signal to the hub station; and
the hub station,
when transmitting a signal to one of the terminal stations among the multiple terminal stations, calculating an adaptive filter minimizing a power of the error signal based on the error signal and a signal to be transmitted to another of the terminal stations,
generating a transmission signal including the prescribed known signal,
performing a filtering process by the adaptive filter on the signal to be transmitted to the other of the terminal stations to generate a cancellation signal for cancelling, regarding the transmission signal, interference due to the signal to be transmitted to the other of the terminal stations,
generating a combined signal by combining the transmission signal and the cancellation signal, and
transmitting the combined signal to the one of the terminal stations.
